(19) United States
(12) Patent Application Publication
(10) Pub. No.: US 2014/0379698 A1
(43) Pub. Date: Dec. 25, 2014

(54) Method for Document Assembly with Margin, Page Size, and Font Controls By County and Document

(71) Applicant: Scott Gerard Wolfe, JR., New Orleans, LA (US)

(72) Inventor: Scott Gerard Wolfe, JR., New Orleans, LA (US)

(21) Appl. No.: 14/310,390

(22) Filed: Jun. 20, 2014

Related U.S. Application Data
(60) Provisional application No. 61/837,733, filed on Jun. 21, 2013.

(51) Int. Cl. G06F 17/30

(52) U.S. Cl. CPC G06F 17/30011; G06F 17/30115
USPC 707/722

(57) ABSTRACT

A system and method, using a computer or computer program, to calculate and determine certain document features, such as paper/page size, document margins, font styles, font weight, and font sizes, that are applied to a document or form generated or managed by a system. The calculation and/or determination of the document features is made pursuant to a system and method, using a computer or computer program, of associating the document feature elements with certain characteristics of the document or form being created or managed by the system, of which the characteristics may include, but are not limited to, associations with certain counties, destination recording offices or filing locations, and document types.

### CROSS REFERENCE TO RELATED APPLICATIONS

This Nonprovisionsal Utility patent application claims the benefit of a previously filed provisional patent under 35 USC 199(e), the application number of which is 61/837,733.

### STATEMENT REGARDING FEDERALLY SPONSORED RESEARCH OR DEVELOPMENT

Not applicable.

### REFERENCE OF SEQUENCE LISTING, A TABLE, OR A COMPUTER PROGRAM LISTING COMPACT DISC APPENDIX

Not applicable

### BACKGROUND OF THE INVENTION

This present invention relates to the field of document recording and record keeping. All across the United States, local county governments and state governments contain a variety of offices that accept filings for recordation. An example of theses type of offices are the property recording offices. Such property recording offices are located in every county across the country, and exists to collect and record documents related to property records within the county. The documents recorded in these offices include, but are not limited to, mortgages, quit claim deeds, and mechanics lien claims.

The rules vary significantly from state-to-state and county-to-county with respect to what can and cannot be recorded, the method of recording, and how the documents must be formatted to be recorded.

This invention relates most specifically to the formatting requirements between county offices. Each county office may have different requirements for the paper sizes accepted, the margins around the document text that is allowed, and minimum and maximum font sizes.

Furthermore, the documents themselves are also regulated by state law requirements, such that some documents may require a minimum font size or font weight, in accordance with state law requirements.

This invention creates a system and method of generating document files, editing document files, managing document files, or otherwise creating or altering documents that have formatted margins, font, font size and font weight that conform to the requirements set by the document's ultimate destination, and if applicable, by regulation of the document itself, which is managed by a database of document destinations and their associated requirements. For the purpose of this invention, documents may be electronically created and stored documents, or documents that are ultimately reduced to paper format.

### SUMMARY OF THE ART

### I. Document Assembly Software

Document assembly software and systems exist to assist users in the creation of template documents. In a typical scenario, the user will set up document templates, which are frameworks for the contents of a particular document. The content of a document template will depend on variable data, which is data that may change from circumstance to circumstance.

Thereafter, a user can dictate to the system certain variables, and the system can produce the template document using the dictated variables.

These systems are commonly used to create contracts or letters. A user will create a letter template, and then later input into the system certain variable data. The system will create a letter for the user that merges the variable data into the letter template.

Oftentimes, a “wizard” is created to collect the variable data from a user. The “wizard” is a questionnaire whereby the system asks the user to answer simple questions which will provide the system with the variable data required to fill in the template.

So, in the example of a letter template, if the letter requires the name and address of the person who will receive the letter, the “wizard” questionnaire will ask the user to provide the name and address of the recipient of the letter. When the user provides this to the “wizard,” the document assembly system will create the letter inserting this information into the designated area of the template.

### II. Recording Offices, Government Institutions and Other Documentary Receptacles

Each year, millions upon millions of documents are recorded by recording offices all across the world. Depending on a recording offices' requirements, the documents may be recorded in person, by mail or electronically. Nevertheless, each recording offices' indexing process requires that the documents for recording be sent to them with certain formatting standards. These standards typically control the document's margins, paper size, and font.

Because these standards are dictated by recording institutions, they are different county-to-county, as documents are typically recorded at county level offices.

### III. Legal Formatting Requirements

Furthermore, state and federal law frequently require the filing or delivery of certain notices and documents (collectively, “documents”). These documents may be regulated or unregulated in their formatting. When regulated, the laws typically require that the documents have a certain minimum font size or font weight.

### IV. Document Assembly Software Fails to Accommodate the Document's Destination

Document assembly software and systems are excellent at generating documents based on pre-defined templates. These systems, however, fail to accommodate for the document's ultimate destination. While they allow margin control globally across the system, or enable the user to manage margins, font, page size, and other features on a document-by-document basis, they fail to automate or technologically enable the documents to be created or managed with the formatting requirements of the document's desired destination in mind.

This invention does not claim anything related to the generation and production of documents in general by document generation software, word processing software, or any other software, process, platform, method, or system, of merging forms, generating documents, or otherwise creating textual content. Instead, this invention merely claims methods by the system of automatically formatting the documents to meet formatting requirements that change dynamically depending on the document and the ultimate destination and use for the document, such information being gathered by the system and method described in this application.

### BRIEF SUMMARY OF THE INVENTION

This invention, through a computer or computer program, creates a system method, and process of generating document files, editing document files, managing document files, or otherwise creating or altering documents that have formatted margins, font, font size and font weight that conform to the requirements set by the document's ultimate destination, and if applicable, by regulation of the document itself, which is managed by a database of document destinations and their associated requirements. For the purpose of this invention, documents may be electronically created and stored documents, or documents that are ultimately reduced to paper format.

The example use and implementation of this invention, referred to through this application, is the filing of a property record, such as a mechanics lien claim, with a county recording office. In this example implementation, the invention is applicable to the following illustrative uses: (i) Software products that assist users in the preparation of property documents, such as mechanic liens; (ii) Service organizations that assist users in the preparation of property documents, such as mechanics liens; (iii) Document assembly software publishers and users; and (iv) Electronic Recording platforms that connect “submitter” users with “recorder” offices.

Many of these applicable uses for this invention may generate, manage, or process a high volume of documents that are ultimately recorded with a recording office. However, because of the county recording formatting requirements that may be different from office-to-office, the documents must be augmented on an ad hoc or case-by-case basis, or must be generated, managed, or processed using some global document element settings. The benefit bestowed by this invention is to enable these applicable use cases to generated, manage, or process the documents in a way that renders them complete and ready to record without further manual or ad hoc augmenting pursuant to the recording office's specific formatting standards, and, if applicable, in conformance with state law regulations on the document.

### BRIEF DESCRIPTION OF THE DRAWINGS

FIG. 1: Document Destination Database Table

The system contains a database table to control the multiple document destinations. Each destination (i.e. county recorder offices) is associated with the formatting variables. These include: (i) The right page margin; (ii) The left page margin; (iii) The top page margin; (iv) The bottom page margin; (v) The top page margin for the first page of the document; (vi) The paper size; (vii) The minimum font size. These seven items are referred to herein as the “Formatting Set.”

Further, since some document destination offices have multiple formatting requirements depending on the (i) type of document being recorded; and/or (ii) Whether the document is being recorded manually or electronically, the administrator may create additional Formatting Sets for these scenarios. To create a Formatting Set, the administrator will indicate to the system its desire to create an additional set and will name the set. One set will be noted as the default. When a document is generated and set to be recorded with a document destination with multiple Formatting Sets, the default will be selected, but the user will have the ability to override the default.

FIG. 2: Document Formatting Table Items

Each document template within the document assembly system may be subject to unique formatting specifications. These formatting specifications may be in addition to, or in the alternative to, the document destination requirements. The system should include the ability for administrators to dictate formatting requirements on a document by document basis, and then to indicate whether the document specific formatting requirement does or does not override the destination requirement.

FIG. 3: Default Formatting Options

Although it is common for document destination offices to mandate formatting requirements, there are times when the destination office doesn't have these requirements or only has some of the many potential requirements. Therefore, the system must have a default set of formatting options that apply if the document destination office does not have more specific requirements.

FIG. 4: System of Choosing Document Destination After Assembly

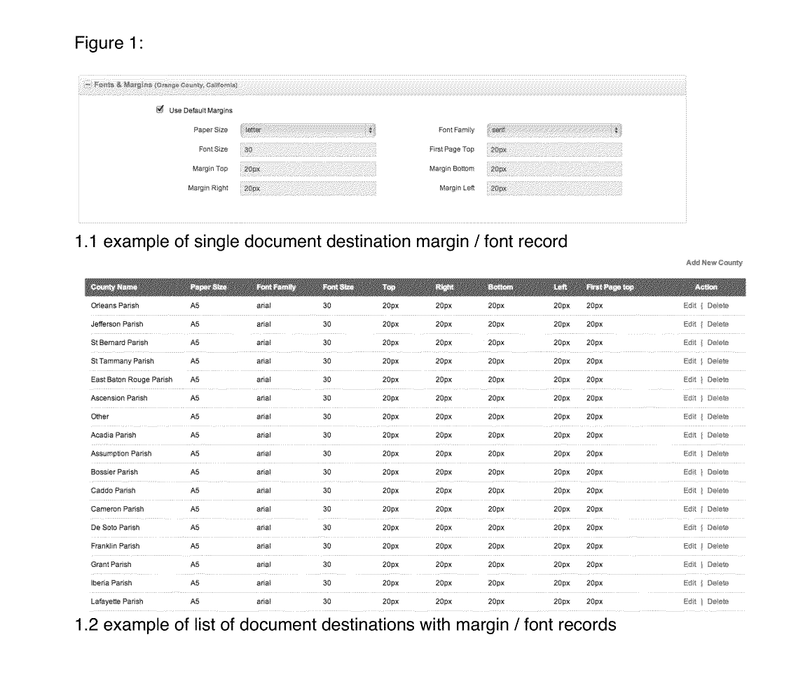

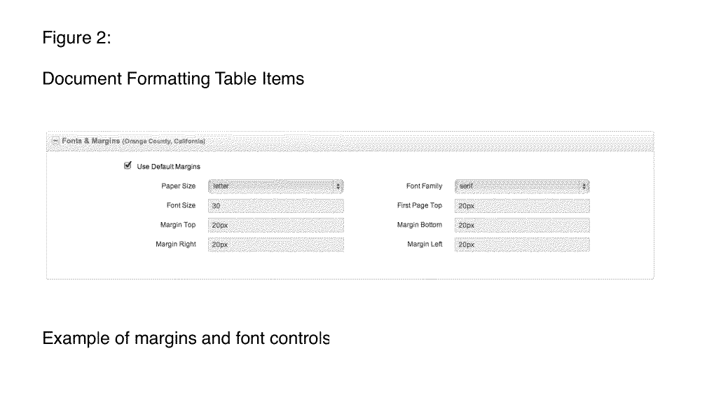

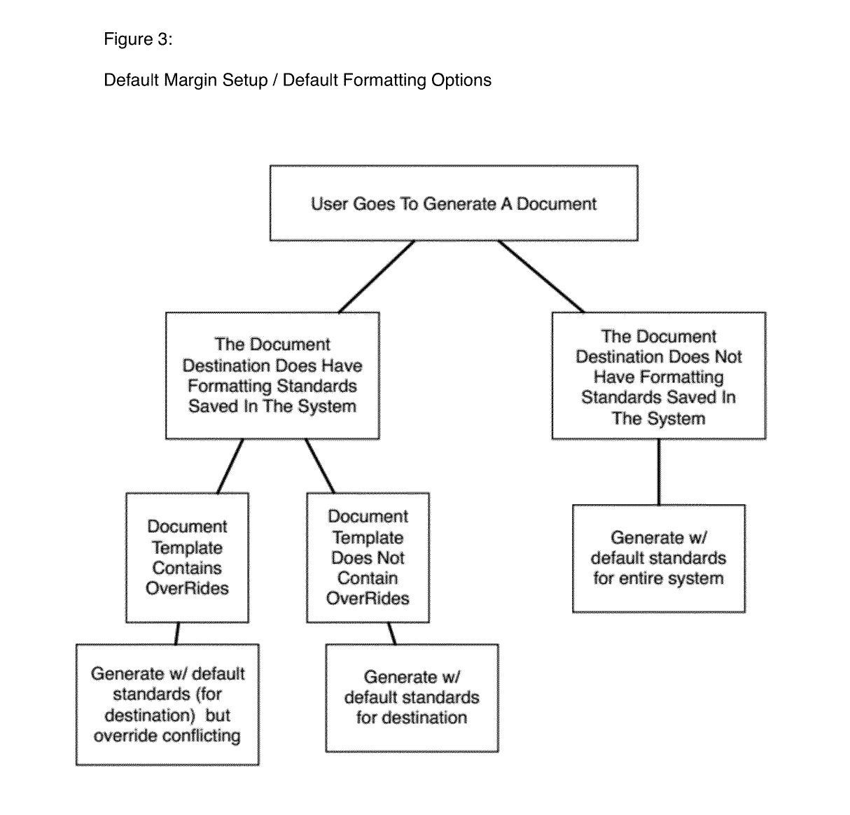

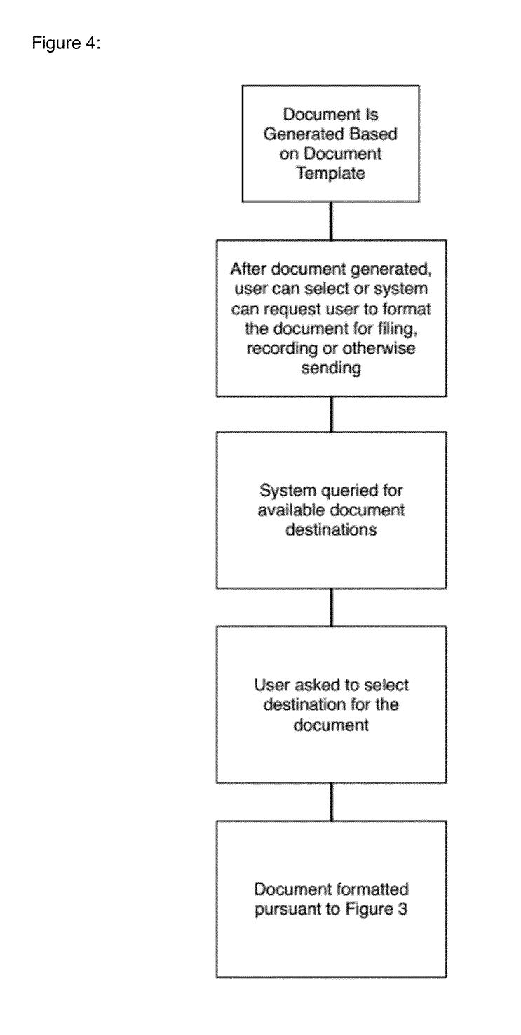

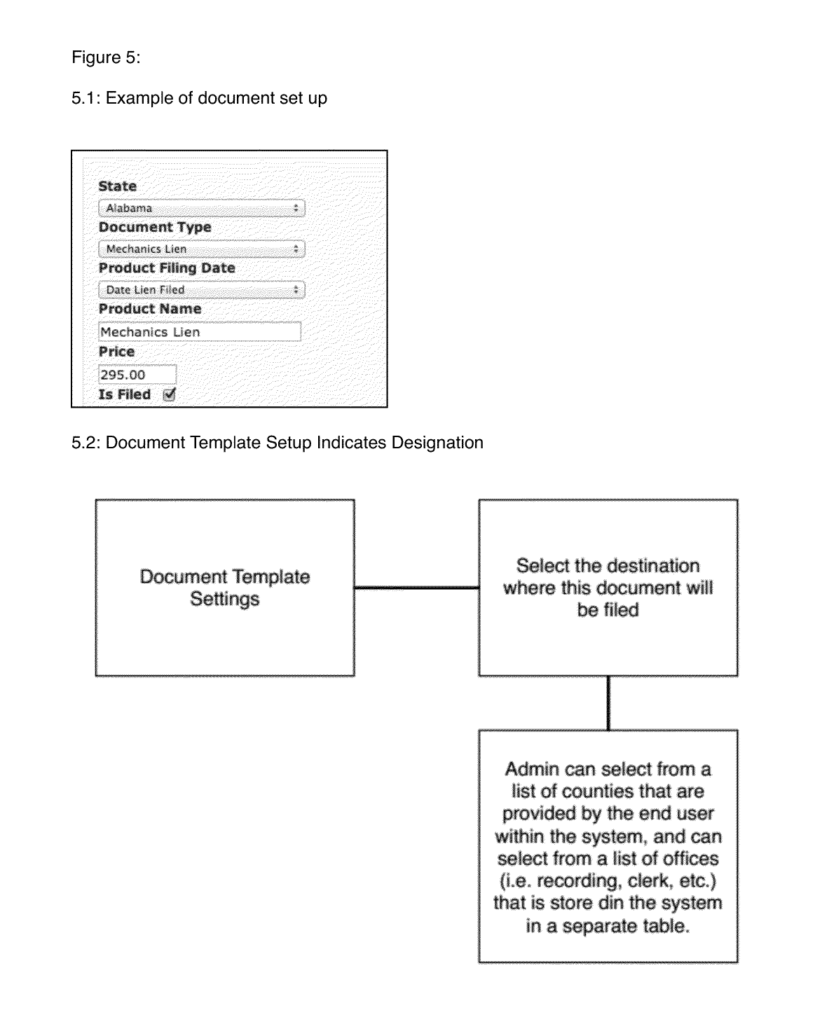

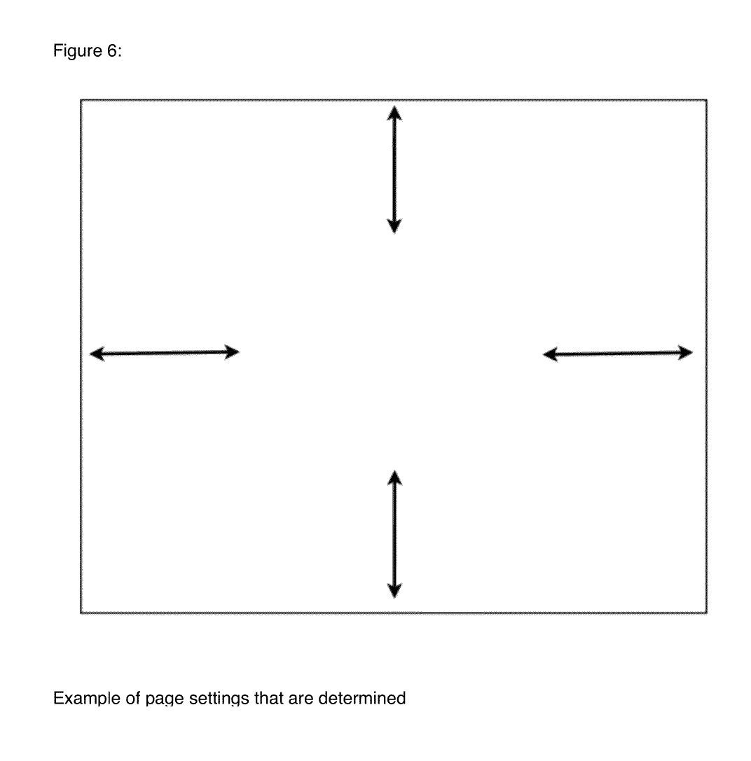

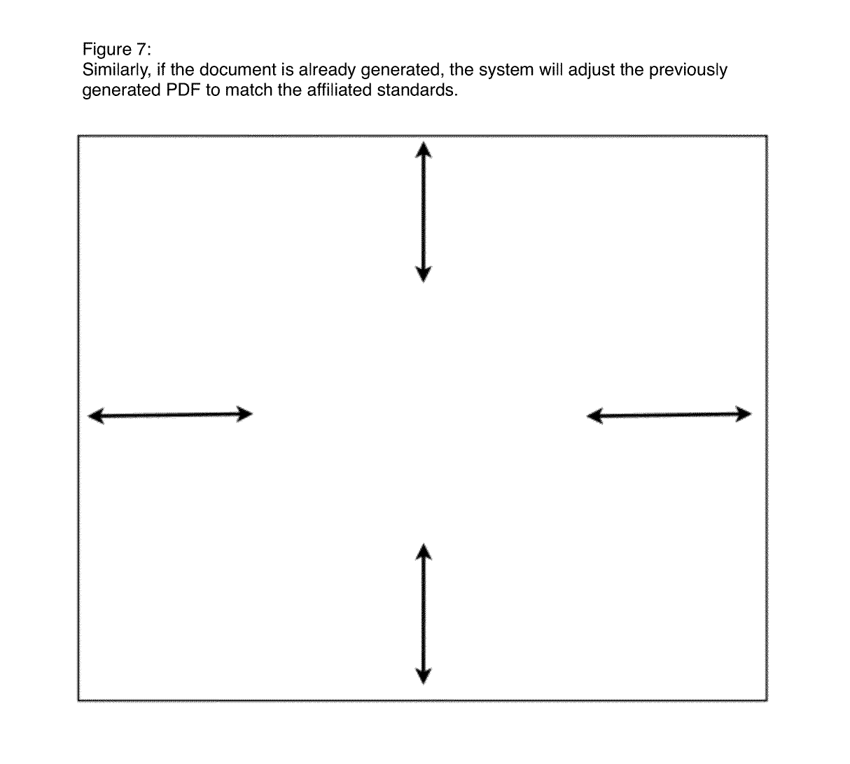

After a document is assembled by a document assembly system, the system provides the user the ability to choose a destination. The destinations available will be displayed based on the list of destinations within the Document Destination Formatting Table described and demonstrated in FIG. 1. After the destination is chosen, the document assembly system will format the document template to meet the destination's standards.

FIG. 5: System of Understanding Document Destination Based Upon Document

Characteristic (Filed or Not Filed Database Option) and Filing Location (Based Upon Manual Input or Data Variables Collected By System) While there may be a system allowing the user to select an applicable destination, it may be possible for the system to automatically understand the document's destination. This may be done by the following:
(i) Each document template may have parameters indicating whether the document is or is not recorded. If the document is recorded, the system will always look for an applicable destination to determine the recording standards, or will use the default standards;
(ii) The system may collect information from the user when acquiring the data variables through a Wizard, questionnaire or similar interface. A field may be applicable within the questionnaire as to the document's destination. In many cases, a document is recorded in a county where the subject of the document (i.e. person or property) resides. If that is the case, the system may determine the document destination by receiving data about the subject of the document.

FIG. 6: System of Formatting Document Depending on Document Destination Database Table

When a document is being generated, the system will look to the document destination, and will adjust the standards for the document to meet the requirements housed within the Document Destination Database Table outlined in FIG. 1, or other applicable standards.

FIG. 7: System of adjusting a previously generated document to meet the formatting requirements of a document destination.

Otherwise, if a document is already generated, the system will actually adjust the document by shrinking and/or expanding the contents therein, to meet the required standards.

### DETAILED DESCRIPTION OF THE INVENTION

This invention creates a system and method of generating document files that have formatted margins, font, font size and font weight that conform to the requirements set by the document's ultimate destination, which is managed by a database of document destinations and their associated requirements.

The system subject to this application contains a framework for storing document formatting information in a database of document destinations. Accordingly, when a document is generated using some system of document assembly, the document assembly system will adjust the document's formatting to meet the destination's requirements.

The system contains a database table to control the multiple document destinations. Each destination (i.e. county recorder offices) is associated with the formatting variables. These include: (i) The right page margin; (ii) The left page margin; (iii) The top page margin; (iv) The bottom page margin; (v) The top page margin for the first page of the document; (vi) The paper size; (vii) The minimum font size. These seven items are referred to herein as the “Formatting Set.”

Further, since some document destination offices have multiple formatting requirements depending on the (i) type of document being recorded; and/or (ii) Whether the document is being recorded manually or electronically, the administrator may create additional Formatting Sets for these scenarios. To create a Formatting Set, the administrator will indicate to the system its desire to create an additional set and will name the set. One set will be noted as the default. When a document is generated and set to be recorded with a document destination with multiple Formatting Sets, the default will be selected, but the user will have the ability to override the default.

Each document template within the document assembly system may be subject to unique formatting specifications. These formatting specifications may be in addition to, or in the alternative to, the document destination requirements. The system should include the ability for administrators to dictate formatting requirements on a document by document basis, and then to indicate whether the document specific formatting requirement does or does not override the destination requirement.

Although it is common for document destination offices to mandate formatting requirements, there are times when the destination office doesn't have these requirements or only has some of the many potential requirements. Therefore, the system must have a default set of formatting options that apply if the document destination office does not have more specific requirements.

After a document is assembled by a document assembly system, the system provides the user the ability to choose a destination. The destinations available will be displayed based on the list of destinations within the Document Destination Formatting Table described and demonstrated in FIG. 1. After the destination is chosen, the document assembly system will format the document template to meet the destination's standards.

While there may be a system allowing the user to select an applicable destination, it may be possible for the system to automatically understand the document's destination. This may be done by the following:
(i) Each document template may have parameters indicating whether the document is or is not recorded. If the document is recorded, the system will always look for an applicable destination to determine the recording standards, or will use the default standards;
(ii) The system may collect information from the user when acquiring the data variables through a Wizard, questionnaire or similar interface. A field may be applicable within the questionnaire as to the document's destination. In many cases, a document is recorded in a county where the subject of the document (i.e. person or property) resides. If that is the case, the system may determine the document destination by receiving data about the subject of the document.

When a document is being generated, the system will look to the document destination, and will adjust the standards for the document to meet the requirements housed within the Document Destination Database Table outlined in FIG. 1, or other applicable standards. Otherwise, if a document is already generated, the system will actually adjust the document by shrinking and/or expanding the contents therein, to meet the required standards.

A system and method, using a computer or computer program, to calculate and determine certain document features, such as paper/page size, document margins, font styles, font weight, and font sizes, that are applied to a document or form generated or managed by a system. The calculation and/or determination of the document features is made pursuant to a system and method, using a computer or computer program, of associating the document feature elements with certain characteristics of the document or form being created or managed by the system, of which the characteristics may include, but are not limited to, associations with certain counties, destination recording offices or filing locations, and document types.

What is claimed is:

1. A computer implemented method and system of calculating and determining certain document features, such as paper/page size, document margins, font styles, font weight, and font sizes, that are applicable to a document or form produced or processed by a system to meet some set of requirements for the document, through the method comprising the steps of:
a. Storing, by the computer or computer program into a computer system, file, program, database, or data source, individual records identifying each potential document destination, such as a record of county recording office locations;
b. Storing, by the computer or computer program into a computer system, file, program, database, or data source, individual records identifying document formatting elements, such as paper/page size, document margins, font styles, font weight, and font sizes;
c. Storing, by the computer or computer program into a computer system, file, program, database, or data source, individual records that associate the records stored pursuant to subpart (b), supra, with applicable records stored pursuant to subpart (a), supra, such that the subpart (a) document destinations are associated with subpart (b)'s document element formatting requirements;
d. Requesting from the user of a system, by the computer or computer program, that the user identify whether the document being produced or processed by the system will require filing or any special formatting requirements;
e. If the user affirms that filing or special formatting requirements are needed, then Requesting from the user of a system, by the computer or computer program, that the user identify the document destination (as stored in the system pursuant to subpart (a) supra, for a document being processed or produced by the system;
f. Examining and determining, by the computer or computer program, the document elements, stored by the system pursuant to subpart (b) supra, that is applicable to the selected document destination;
g. Altering, by the computer or computer program, the characteristics of the document to satisfy the associated formatting requirements, such as altering the page's margins, adjusting the text's font size, and/or changing the paper and page size.
h. Producing or providing, by the computer or computer program, a document with the adjusted document element parameters, and providing the same to the system user.

2. The method of claim 1 wherein the need for filing or special formatting requirements is calculated by the system, through the computer or computer program, and not selected by the user pursuant to subpart (d), through the method comprising the steps of:
a. Storing, by the computer or computer program into a computer system, file, program, database, or data source, individual records identifying document records, which are records of different types of documents, document forms, document instructions, or other data associated with a document that will ultimately be produced or processed by the system;
b. Storing, by the computer or computer program into a computer system, file, program, database, or data source, an identification as to whether the document is filed or has specialty formatting requirements;
c. When proceeding through the method of claim 1, instead of requesting that the user indicate whether specialty formatting requirements or filing is required as per subpart (d) of the claim 1, the system will instead examine, through the computer or computer program, examine and determine, the subject document being processed or produced and determine, again through the computer or computer program, whether the subject document is associated with an identification of filing or specialty formatting requirements as stored pursuant to foregoing subpart (b).

3. The method of claim 1 wherein the document destination is calculated by the system, through the computer or computer program, and not selected by the user pursuant to subpart (e), through the method comprising the steps of:
a. Collecting, by the computer or computer program, through some interface that collects data from the user about the document being produced or processed, data fields that identify the document's destination;
b. Storing, by the computer or computer program into a computer system, file, program, database, or data source, an identification as to the document destination associated with the document being produced or processed;
c. When proceeding through the method of claim 1, instead of requesting that the user indicate the document destination as per subpart (e) of the claim 1, the system will instead examine, through the computer or computer program, the subject document being processed or produced and determine, again through the computer or computer program, whether the subject document is associated with an identification of the document destination as stored pursuant to foregoing subpart (b).

4. The method of claim 1 wherein, through the computer or computer program, the user either selects that the subject document requires filing or specialty formatting requirements (i.e. claim 1, subpart (d)) or the system, through the computer or computer program, determines and calculates that the subject document requires filing or specialty formatting requirements (i.e. claim 2), but when there is no association of any document elements with the document and/or document destination, then preparing, processing or producing the document through the method comprising the steps of:
a. Storing, by the computer or computer program into a computer system, file, program, database, or data source, individual records identifying global default document formatting elements, such as paper/page size, document margins, font styles, font weight, and font sizes;
b. Examining, by the computer or computer program, the global document elements as stored pursuant to the foregoing subpart (a), and using said global document elements to prepare, produce, or process the subject document.

5. The method of claim 1 wherein, through the computer or computer program, the subject document record within the computer system, file, program, database, or data source, contains individual records that identify overriding document element data, and using said overriding document elements to perform the method of claim 1, through the method comprising the steps of:
a. Storing, by the computer or computer program into a computer system, file, program, database, or data source, individual records identifying each potential document;
b. Storing, by the computer or computer program into a computer system, file, program, database, or data source, individual records identifying document formatting elements, such as paper/page size, document margins, font styles, font weight, and font sizes;
c. Storing, by the computer or computer program into a computer system, file, program, database, or data source, individual records that associate the records stored pursuant to claim 5 subpart (b), with applicable records stored pursuant to claim 5 subpart (a), such that the subpart (a) document records are associated with subpart (b)'s document element formatting requirements;
d. Examining, through the computer or computer program, whether the subject document requires filing or specialty formatting requirements, and determining the same, through the methods described in claims 1-3;
e. If filing or specialty formatting requirements are needed, as determined by the computer or computer system pursuant to claim 5 subpart (d), then examining and determining, through the computer or computer program, if an applicable record exists within the computer system, file, program, database, or data source, stored by the computer program or computer pursuant to claim 5 subpart (c);
f. If such records exist, then to compare, by the computer or computer program, the document element requirements of claim 5 subpart (e) with the document element requirements determined by the system through claims 1-3, and to override and replace any document element requirements associated with the subject document that is determined by the system through claims 1-3 with the document element requirements of claim 5 subpart (e).
